(19) United States
(12) Patent Application Publication
(10) Pub. No.: US 2011/0126419 A1
(43) Pub. Date: Jun. 2, 2011

(54) DRYING APPLIANCE COMPRISING A HEAT EXCHANGER HAVING A COATING

(75) Inventors: Jose Luis Castillo Fernandez, Tafalla (ES); Klaus Grunert, Berlin (DE); Harald Pietsch, Berlin (DE); Roberto San Martin Sancho, Estella (ES)

(73) Assignee: BSH BOSCH UND SIEMENS HAUSGERÄTE GMBH, Munich (DE)

(21) Appl. No.: 13/056,170

(22) PCT Filed: Aug. 4, 2009
(86) PCT No.: PCT/EP09/60074

§ 371 Date: Jan. 27, 2011

(30) Foreign Application Priority Data
Aug. 14, 2008 (EP) 08105040.3

(51) Int. Cl. F26B 21/00; F28F 13/18; F28G 15/00

(52) U.S. Cl. 34/72; 165/133; 165/95

(57) ABSTRACT

A drying appliance having a drying chamber and a process air guide for guiding drying air through the drying chamber. The process air guide has a heat exchanger for cooling process air which includes a charge of humidity and particulates, and which is disposed downstream of the drying chamber within the process air guide. The heat exchanger is coated at least partially with a polymer coating on a part of a surface of the heat exchanger. The part of the surface below the coating has a passivating layer interposed between the coating and the surface.

The invention relates to a drying appliance comprising a drying chamber and a process air guide for guiding drying air through said drying chamber, said process air guide comprising a heat exchanger for cooling process air which comprises a charge of humidity and particulates, and disposed downstream of said drying chamber within said process air guide, wherein said heat exchanger is coated at least partially with a polymer coating on a part of a surface of the heat exchanger.

A heat exchanger in a drying appliance like a household laundry dryer has to fulfil several requirements in order to effectively exchange heat. First of all, the heat conductivity of its body should be good. Moreover, a surface of a heat exchanger exposed to any kind of dirt or dust should be easy to clean since any dirt or dust adhering to the surface would tend to reduce the efficiency of a heat exchanger. This is especially true for a heat exchanger in a dryer that is commonly used for drying wet clothes.

International Patent Application PCT/EP2009/052028 filed Feb. 20, 2009 and claiming a German priority dated Feb. 22, 2008, and fully incorporated herein by reference, discloses a dryer comprising a heat exchanger dedicated to cooling a process air which has a polymer coating on a surface exposed to a charge of humidity and particulates comprised by the process air, in particular small particulate matter, namely lint. Every heat exchanger operable as a heat sink in a dryer that recirculates process air to dry laundry is apt to be covered with lint, and other particulates that have passed a lint screen that is generally disposed upstream of the heat sink, and thus stick to the exposed surface of the heat exchanger. Moreover, a heat exchanger in a dryer may come into contact with humidity at elevated temperatures. Under these conditions, lint and other particulates tend to stick even better to the wet surface of the heat exchanger. These particles can be removed in principle by flushing with water. It is however useful if these particles do not stick too strongly to the surface.

The cleaning of a heat exchanger in a dryer generally depends on the type of the heat exchanger. In general, a dryer for drying humid laundry contains as drying chamber a rotatable drum to contain the wet laundry, and additional air passages, in which process air is circulated. Prior to entry into the drying chamber, the process air is heated by a heat source, so that it can absorb humidity from the laundry which may be tumbled in the drying chamber. After passing through the drying chamber, the process air is charged with humidity, but also with fine particles released from the laundry and specified as lint or fluff in general. It first reaches a lint filter or fluff filter, whereon these fine particles are predominantly collected, and then a heat sink where the process air is cooled to precipitate the humidity that it is charged with. During this cooling process, the humidity condenses and is separated from the process air. From the heat sink, the process air may flow back to the heat source, where it is reheated and guided back to the drying chamber. Although the lint filter catches and retains a significant proportion of the lint, the heat sink is nevertheless also noticeably contaminated with the finest particles which the lint filter could not collect. That load may become relatively high because the lint is deposited on and more or less sticks to the surface of the heat sink facing the process air, a process to which the condensed water in the heat sink contributes significantly.

An air-to-air heat exchanger for use as a heat sink is generally designed to be easily detached from the remainder of the dryer once a certain number of drying processes is completed. Cleaning is then easily effected by rinsing with water. After the rinsing, the heat exchanger is replaced into the dryer that is then ready for another number of drying processes. Detaching and replacing the heat exchanger can be done by any layperson without need to call on a skilled service specialist.

The situation is different if the heat sink is part of a heat pump. Dryers for drying laundry using a heat pump are disclosed in the documents WO 2007/093461 A1, WO 2007/093467 A1, and WO 2007/093468 A1, according to which the cleaning of the heat exchanger involves the use of brushes and additional liquid. If the heat sink is part of a heat pump wherein the heat removed from the process air in the heat sink is pumped to the heat source to be used to heat the process air once again, it is in general not possible to have an easily detachable heat sink. For example, the compressor-type heat pump specified below connects the heat sink and the heat source in a heat transport circuit wherein a working medium or refrigerant circulates, for example a fluorinated hydrocarbon compound. The working medium flows in liquid form to the heat sink where it evaporates by means of heat from the process air. The evaporated working medium is guided to a compressor. There it is compressed and conveyed to the heat source where it becomes liquid again by transferring heat to the process air. The liquid working medium traverses a throttle behind the heat source, for example a valve, a diaphragm or a capillary, where its internal pressure and temperature decreases, and moves back to the heat sink, thus completing the circuit. The working medium circuit should be completely sealed to its ambient in order to ensure a long lifetime. This is normally achieved by sealing all components and joints between them tightly by soldering or brazing. Removal of the heat sink from the dryer is thus in general not possible without damaging the heat pump. The same applies if the heat pump is a thermoelectric heat pump based upon the utilization of the Peltier effect. Accordingly, any necessary cleaning of the heat exchanger must be done while leaving the heat exchanger at its proper place in the dryer.

The coating of a heat exchanger operable as a heat sink, in particular its fins (if present), should contribute to an easy cleaning of the heat exchanger. However, during the drying process the wet and hot process air stresses the coating (in general a polymer coating) such that unwanted effects as increasing the surface energy and delaminating the coating from the surface may occur. Particles can then stick much easier to the non-protected surface and might be more difficult to remove. In the case where the heat exchanger is made of aluminium, aluminium oxide may form which could contribute to the delaminating of the coating and an overall worsening of the surface characteristics. In the latter case, aluminium oxide could stem also from the transport of a heat exchanger under a salty atmosphere as may occur during a sea transport of a household appliance comprising the heat exchanger.

DE 103 30 744 A1 discloses a coating system based on a polysiloxane resin formed from hydrolysable silane with a high hydrolysis speed. This coating system provides functional coatings with different properties; it is in particular easily cleanable and highly scratch resistant and also suitable for substrates made of glass, ceramic, metal, stone and plastic. The coating system of “example 2” is described to provide a hydrophobic easy-to-clean coating using very little surface energy, on the basis of which dirt and liquids can only weakly adhere to the coating. Thus the coated surface does not become heavily soiled and is easy to clean. Yet, no application of the coating system is disclosed.

Further examples for easy-to-clean coatings based on polysiloxane resins are disclosed in WO 2001/064 801 A1, in particular its Examples 2B, 9, 34, 39 and 40. The coating renders the surface dirt-repellent, scratch-resistant and in some cases resistant towards high temperatures. The use of the coating for the protection of masonry from unwanted graffiti and for corrosion-resistant non-sticky cookware, ovens, coated outer surfaces of automobiles and other equipment is disclosed.

DE 101 06 213 A1 discloses a self-cleaning lacquer coating, characterized by a surface structured by nanometre-sized particles. The coating may be applied to glass, ceramics, plastics, metals, and glazed or enamelled substrates. Yet, the thickness of the lacquer precludes its application to a surface where superior heat conductivity is a material requirement.

WO 2008/048252 A1 relates to a refrigeration unit comprising a micro channel heat exchanger, the refrigeration unit dedicated to use on a shipping container to transport refrigerated goods by rail, road, or ship. The micro channel heat exchanger is a heat source or liquefier to radiate heat off a refrigeration circuit into an environment. It is made from flat aluminium tubing, and it has a coating composed of an acrylic resin preparation to provide resistance to corrosion under exposure to aggressive, in particular marine, environments.

U.S. Pat. No. 4,830,101 relates to a heat exchanger of an automotive air conditioner. The heat exchanger is made of aluminium, and it has a coating to be exposed to a humid air flow, with the coating made of a water-soluble high polymer material to provide improved corrosion resistance and wettability by water, and reduced scattering of condensed water. A point is also made to improve the adherence of the coating to the aluminium substrate.

WO 2008/095 927 A1 relates to a substrate composed of an aluminium or magnesium base material comprising the respective essentially pure metal and alloys, which is rendered resistant to corrosion by automotive or stationary exhaust fumes at elevated temperatures by a coating. The coating comprises a passivation layer deposited directly on the substrate by a wet-chemical process, and a corrosion-resistant layer formed of an organically modified polysiloxane.

An object of the present invention is thus the provision of a drying appliance comprising a heat exchanger as defined above with an improved coating which is particularly useful under the conditions which are encountered by a heat sink in a laundry appliance, in particular a clothes dryer.

This object is achieved by the drying appliance as defined in the independent patent claim attached. Preferred embodiments of the appliance are specified in dependent patent claims.

The invention thus provides a drying appliance comprising a drying chamber and a process air guide for guiding drying air through said drying chamber, said process air guide comprising a heat exchanger for cooling process air which comprises a charge of humidity and particulates, and disposed downstream of said drying chamber within said process air guide, wherein said heat exchanger is coated at least partially with a polymer coating on a part of a surface of the heat exchanger, and wherein the part of said surface below said coating has a passivating layer interposed between said coating and said surface.

By providing the passivating layer, a well-defined and stable interface is provided for bonding the polymer coating to the surface. The passivating layer provides the surface with a chemical stability that surpasses the stability of the surface without any passivation, and will prevent oxidation or any other degradation. In addition, the passivating layer improves the adherence of the polymer coating to the surface. To make the passivating layer, a variety of compounds and formulations including phosphate and chromate compounds dissolved in appropriately composed liquid formulations is commercially available for this purpose.

In accordance with a preferred embodiment of the invention, the passivating layer comprises a chromium compound. Even more preferred, that chromium compound comprises Cr(III) ions.

In accordance with another preferred embodiment of the invention, the coating has a surface energy not exceeding 40 mN/m, in particular not exceeding 30 mN/m.

The surface energy can be measured by dropping commercially available testing inks that are pigmented liquids having special properties. The behaviour of these inks on the surface to be examined can be used to determine the surface energy. The surface energy is determined based on the extent to which a drop of such an ink runs on the surface or whether it remains as more or less ball-shaped drop on the surface.

The heat exchanger according to the invention can be made of a variety of materials, in particular of plastic or metal. Preferably the heat exchanger comprises a metal such as aluminium, magnesium or copper. More preferably, the heat exchanger comprises more than 90% aluminium. In particular, the heat exchanger consists of aluminium.

The heat exchanger of the present invention is preferably obtained by a process comprising the steps:
(a) pretreating at least the part of the surface to be coated with a detergent, phosphate and/or borate containing solution,
(b) rinsing the surface with water,
(c) treating the surface with a passivating agent to yield a passivating layer
(d) rinsing the passivated layer with water, and
(e) coating the passivating layer with a polymer.

For the coating, numerous polymers can be used as long as they allow the provision of a coating with a surface energy not exceeding 40 mN/m. For the present invention, however, a polymer coating has been found to be particularly suitable that comprises a polysiloxane resin. Preferably, the polysiloxane resin is a polyester-modified methyl phenyl polysiloxane resin. Such coatings are of particular advantage in that they can be very thin and are at the same time scratch-resistant, in particular when they are applied on a pre-treated heat exchanger surface. A correspondingly coated heat exchanger can be cleaned with ease, in general by rinsing with water.

In a preferred embodiment of the present invention, ceramic particles, more preferred ceramic particles with a size of approximately 50 nm, are suspended in the polymer coating. The term “ceramic particles” as used herein means particles from essentially inert oxides, hydroxides and the like. Such ceramic particles comprise or consist of in particular silicon dioxide, calcium hydroxide and/or aluminium oxide together with derivatives such as boehmite.

The polymer coating has preferably a thickness of from 1 μm to 50 μm, more preferably of from 1 μm to 10 μm and most preferably of from 1 μm to 5 μm. The thickness of this coating can be measured in particular by means of scanning electron microscopy.

In a particular embodiment of the heat exchanger and the dryer of the present invention, the polymer coating comprises a pigment, in particular a dye. The pigment is preferably selected such that it fluoresces in visible light when irradiated with ultraviolet light. This embodiment allows to easily control whether the polymer coating has been accomplished as desired. Advantageously, the heat exchanger of the present invention thus contains suspended in the polymer coating a pigment that fluoresces in visible light when it is irradiated with ultraviolet light.

In a particularly preferred heat exchanger of the present invention, the surface energy changes by less than 5%, preferably less than 3%, when the heat exchanger is treated at a temperature of 70° C. with air of 100% relative humidity for 1250 hours.

The invention encompasses also a preferred embodiment wherein the drying appliance is a household dryer, in particular a laundry dryer. More preferred as well, the heat exchanger is a heat sink in the process air guide within the household dryer. The term “laundry dryer” as used herein not only refers to a laundry dryer as such, but encompasses also a so-called “washer dryer”, wherein both washing and drying of laundry is possible.

The invention is of particular use if the appliance comprises a heat pump with the heat exchanger incorporated into the heat pump, since the components of a heat pump generally cannot be detached for cleaning the air path. Thus, the tendency to accumulating dirt in the air part of a heat pump should be minimized and the method of cleaning as much as possible simplified. The invention lends itself perfectly to that purpose.

In accordance with a concomitant preferred embodiment of the invention, the heat exchanger is provided with a cleaning device for cleaning said heat exchanger from adhering particulate matter with a cleaning fluid. Thereby, provision is made to effect any necessary cleaning of the heat exchanger by machine action without a need of contribution from a user. This is of major importance in connection with a heat exchanger that is not removable from the appliance, as in the preferred embodiment discussed previously.

An exemplary and preferred embodiment of the invention will now be described in detail.

In this embodiment, the drying appliance is a household laundry dryer. This dryer has a drying chamber and a closed process air guide, in which the drying chamber is incorporated and in which a heat pump is provided with a heat sink and a heat source for alternately cooling and heating the circulating process air. The two heat exchangers functioning as heat sink and heat source are embodied in each instance preferably as meandering tube systems, which are soldered together from individual copper tubes and conduit bends and are held in fins arranged one above the other. These fins are thin metal strips made of aluminium and are used to improve the transfer of heat between the working medium flowing through the tube systems and the process air flowing around the tube systems. The heat sink and the heat source are prefabricated in this form and are then inserted into the dryer. The working medium circuit is closed by soldering the heat sink and the heat source using additional conduit pipes.

It is preferred that the surface of a heat exchanger is essentially completely covered by the coating. This is especially true for the case of a dryer, wherein the heat exchanger should be as completely as possible covered everywhere where it can be reached by process air, in particular at any edges present.

The process for coating a heat exchanger at least partially with a polymer coating on a part of a surface of the heat exchanger, comprises a multiplicity of steps:
(a) pretreating at least the part of the surface to be coated with a polymer coating with a detergent, phosphate and/or borate containing solution,
(b) rinsing the surface with water,
(c) treating the surface with a passivating agent to yield a passivating layer,
(d) rinsing the passivating layer with water, and
(e) coating the passivating layer with a polymer.

The detergent, phosphate and/or borate containing solution in step (a) may be acidic or basic. The use of an acidic or basic (alkaline) liquid is of particular advantage when the heat exchanger comprises or consists of aluminium in that it serves to remove aluminium oxide from the surface to be coated. The solution thus comprises an anionic and/or non-ionic tenside, a phosphate and/or borate. As basic agent, for example sodium or potassium hydroxide may be used, in particular sodium hydroxide. Step (a) can be performed by spraying the surface of the heat exchanger with this solution or by immersing the heat exchanger into this solution. The duration of step (a) is 1 to 2 minutes. A temperature range for step (a) is set from 50° C. to 70° C.

The rinsing in step (b) is conducted with pure water. The pure water may be tap or industrial water that has been purified by distillation or by passing over an ion-exchange resin. Step (b) is performed by spraying the surface of the heat exchanger with water or by immersing the heat exchanger into water. The duration of step (b) is up to 1 minute. The temperature may vary broadly. In a preferred embodiment, step (b) can be divided in a step (b1) involving the rinsing with normal water and a step (b2) involving the rinsing with purified water. The term “rinsing” as used herein is used broadly and involves both spraying and immersion.

The water used in step (b) may suitably contain a base or acid. If the solution in step (a) comprises an alkaline substance, it is advantageous to employ in step (b), in particular in a step (b2), a mixture of water and an acid, namely purified water whose pH is adjusted from 3 to 4 by the addition of sulphuric acid. The sulphuric acid will lend itself to a slight pickling of the surface which will provide for thorough cleaning of the surface and may improve the bond between to surface and the passivating layer that is to be provided subsequently. In this process, rinsing with water in step (d) is preferably conducted until the water has a conductivity less than 30 μS/cm.

Moreover, a drying step (f) is performed between step (d) and step (e). The drying step (f) is performed at a temperature T not exceeding 65° C. In this manner, particularly good coatings are obtained wherein cracks in the passivating layer are avoided.

In step (c) various passivating agents may be employed. It has been proven of particular advantage, in particular in combination with a heat exchanger comprising at least 90% aluminium or consisting of aluminium, to use a chromium (III) containing passivating agent. As a result, a thin passivating layer is obtained in general. The treatment of the surface with a passivating agent in step (c) is performed by spraying the surface of the heat exchanger with a solution containing the passivating agent or by immersing the heat exchanger into the solution containing the passivating agent. The duration of step (c) is up to 1 minute. The temperature may vary broadly. A preferred temperature range is however from 30 to 40° C.

The rinsing in step (d) of the passivating layer is conducted with water, in particular pure water. The pure water can be water that has been purified by distillation or by passing over an ion-exchange resin. Step (d) can be performed by spraying the surface of the heat exchanger with water or by immersing the heat exchanger in water. The duration of step (d) is preferably up to 2 minutes, more preferably up to 1 minute. The temperature may vary broadly, although it is preferred to use a temperature not exceeding 40° C. Rinsing with water in step (d) is conducted until the water has a conductivity less than 30 μS/cm.

The polymer coating is applied to the passivating layer by a solution of a polyester-modified methyl phenyl polysiloxane resin combined with a separating substance (which for its part contains nanocrystalline ceramic particles) in an organic solvent, marketed under the name “NP AS 10” by ItN Nanovation AG in Saarbrücken, is used. A pigment is added to the preparation, which fluoresces in visible light when irradiated with ultraviolet light. The preparation is a simple viscous and slightly milky liquid, which is applied by immersing the heat exchanger into it. As an alternative, the preparation could also be applied by spraying. In this way, the heat exchanger including all edges, in particular all edges of its fins will be covered with the polymer coating. The complete covering of the heat exchanger with the polymer coating can be confirmed by illuminating the coated heat exchanger with ultraviolet light in that the pigment in the preparation fluoresces in visible light. Thus, all areas within the surface of the heat exchanger which should be covered with the coating should fluoresce when the heat exchanger is subjected to ultraviolet light.

Subsequently, the coated heat exchanger obtained in step (e) is allowed to dry. Preferably, the coated heat exchanger is shaken for about 30 seconds to 2 minutes, for example 1 minute, in order to drain off surplus preparation in advance of drying.

As a general remark not limited to the exemplary embodiment, the surface bearing the polymer coating need not necessarily correspond to the complete surface of the heat sink. The coating can be restricted to a part of the total surface on to which the process air blows directly. This part is especially prone to the deposit of foreign particles and in order to save polymer coating material, the coating can be restricted to this area. When used in a dryer, the part of the heat sink to be provided with the polymer coating can in particular be the part, which extends in the flow direction of the process air along the heat sink starting from one of the front sides directly facing the flowing process air over a length between 5 mm and 25 mm. Depending on the application, it may be advantageous to provide corresponding components of the heat sink, for instance fin plates and the like, with the coating prior to their processing and their insertion into the heat sink.

As another general remark not limited to the exemplary embodiment, the coating can optionally extend across the entire heat exchanger or can be restricted to any part, on to which the process air blows during operation. Even if the coating is not applied to the entire heat exchanger it may be of advantage to conduct steps (a) to (d) of the process on the entire heat exchanger in that a passivating layer may render the whole surface resistant to corrosion or any other impairment and allow a stable heat transfer during the lifetime of the heat exchanger. This is particularly true in case of an aluminium heat exchanger where the detrimental effect of any formed aluminium oxide may be avoided.

The present invention provides several advantages. The heat exchanger of the present invention has an excellent resistance to the adhesion of fluff. Even if fluff is deposited on the coated heat exchanger, for example during the operation of a dryer comprising this heat exchanger as a heat sink, it adheres only weakly to the surface of the heat exchanger and can be removed using simple means, in particular by dousing with water. The reliability of an automated cleaning system for the heat exchanger is thus significantly increased and a more stable operation of the heat sink and thus of the dryer, which is not impaired by unwanted deposits, is also ensured over a long period of time.

1-14. (canceled)

15. A dryer, comprising:
a drying chamber; and
a process air guide to guide drying air through the drying chamber, the process air guide having a heat exchanger to cool process air that includes a charge of humidity and particulates;
wherein the process air guide is downstream of the drying chamber within the process air guide;
wherein a part of a surface of the heat exchanger is coated at least partially with a hydrophobic polymer coating; and
wherein the part of the surface below the hydrophobic polymer coating has a passivating layer interposed between the hydrophobic polymer coating and the surface.

16. The dryer of claim 15, wherein the passivating layer comprises a chromium compound.

17. The dryer of claim 16, wherein the chromium compound comprises Cr(III)-ions.

18. The dryer of claim 15, wherein the hydrophobic polymer coating has a surface energy not exceeding 40 mN/m.

19. The dryer of claim 18, wherein the surface energy of the hydrophobic polymer coating does not exceed 30 mN/m.

20. The dryer of claim 15, wherein the surface is formed of metal comprising more than 90% aluminium.

21. The dryer of claim 15, wherein the surface is formed of a metal comprising more than 90% aluminium alloy.

22. The dryer of claim 15, wherein the heat exchanger is obtainable by a process comprising:
pretreating at least the part of the surface to be coated with the hydrophobic polymer coating with a detergent-containing solution;
rinsing the surface with water,
treating the surface with a passivating agent to yield the passivating layer;
rinsing the passivating layer with the water; and
coating the passivating layer with the hydrophobic polymer coating.

23. The dryer of claim 15, wherein the hydrophobic polymer coating comprises a polysiloxane resin.

24. The dryer of claim 23, wherein the polysiloxan resin is a polyester-modified methyl phenyl polysiloxane resin.

25. The dryer of claim 15, wherein ceramic particles with a size of approximately 50 nm are suspended in the hydrophobic polymer coating.

26. The dryer of claim 15, wherein the hydrophobic polymer coating has a thickness of 1 μm to 50 μm.

27. The dryer of claim 15, wherein a pigment that fluoresces in visible light when irradiated with ultraviolet light is suspended in the hydrophobic polymer coating.

28. The dryer of claim 15, wherein the dryer is a household dryer.

29. The dryer of claim 15, further comprising a heat pump into which the heat exchanger is incorporated.

30. The dryer of claim 29, wherein the heat exchanger has a cleaning device to clean the heat exchanger from adhering particulate matter with a cleaning fluid.
